(19) United States
(12) Patent Application Publication
(10) Pub. No.: US 2006/0064417 A1
(43) Pub. Date: Mar. 23, 2006

(54) Data mining technique for enhancing library-space management

(75) Inventors: Menachem Levanoni, Poway, CA (US); Jerome M. Kurtzberg, Yorktown Heights, NY (US)

Correspondence Address: Stephen C. Kaufman;IBM CORPORATION, Intellectual Property Law Dept., P.O. Box 218, Yorktown Height, NY, 10598, US

(73) Assignee: International Business Machines Corporation, Armonk, NY (US)

(21) Appl. No.: 10/945,513

(22) Filed: Sep. 20, 2004

(51) Int. Cl. G06F 17/30

(52) U.S. Cl. 707/6

(57) ABSTRACT

A computer method for enhancing library-space management. The method includes the steps of providing a library-space-requirements database comprising a compendium of individual library-space-requirements history; providing a library-space-availability database comprising a compendium of at least one of library-space management solutions, library-space information, and library-space diagnostics; and, employing a data mining technique for interrogating the library-space-requirements and library-space-availability databases for generating an output data stream, the output data stream correlating library-space-requirements problem with library-space-availability solution.

### CROSS REFERENCE TO RELATED APPLICATIONS

This application is related to application Ser. No. 09/604,535 to Levanoni, et al. (IBM docket YOR920000425US1) filed Jun. 27, 2000; to application Ser. No. 09/612,683 to Levanoni, et al. (IBM docket YOR920000446US1) filed Jul. 10, 2000; to application Ser. No. 09/633,830 to Levanoni, et al. (IBM Docket YOR920000508US1) filed Aug. 7, 2000; to application Ser. No. 09/696,552 to Levanoni, et al. (IBM Docket YOR920000590US1) filed Oct. 25, 2000; to application Ser. No. 10/695,142 to Levanoni, et al. (IBM Docket YOR920030568) filed Oct. 28, 2003; and to application Ser. No. 10/695,143 to Levanoni, et al. (IBM Docket YOR920030560US1) filed Oct. 28, 2003. Each of these applications is co-pending and commonly assigned.

### BACKGROUND OF THE INVENTION

1. Field of the Invention

This invention relates to methodology for utilizing data mining techniques in the area of library-space management.

2. Introduction to the Invention

Data mining techniques are known and include disparate technologies, like neural networks, which can work to an end of efficiently discovering valuable, non-obvious information from a large collection of data. The data, in turn, may arise in fields ranging from e.g., marketing, finance, manufacturing, or library science.

### SUMMARY OF THE INVENTION

We have now discovered novel methodology for exploiting the advantages inherent generally in data mining technologies, in the particular field of library-space management applications.

Our work proceeds in the following way.

We have recognized that a typical and important “three-part” paradigm for presently effecting library-space management, is a largely subjective, human paradigm, and therefore exposed to all the vagaries and deficiencies otherwise attendant on human procedures.

In particular, the three-part paradigm we have in mind, works in the following way. First, a library-space manager develops a library-space database comprising a compendium of individual library-space-requirements—e.g., specific library-space-requirements which took place in its past. Secondly, and independently, the library-space manager develops in his mind a shelving availability database comprising the library-space manager's personal, partial, and subjective knowledge of (otherwise objective) library science facts culled from e.g., the marketing literature, the business literature, or input from colleagues or experts. Thirdly, the library-space manager subjectively correlates in his mind the necessarily incomplete and partial shelving-availability database, with the library-space-requirements database, in order to promulgate an individual's library-space-requirements prescribed library-space management and ultimate solution.

This three-part paradigm is part science and part art, and captures one aspect of the problems associated with library-space management. However, as suggested above, it is manifestly a subjective paradigm, and therefore open to human vagaries.

We now disclose a novel computer method which can preserve the advantages inherent in this three-part paradigm, while minimizing the incompleteness and attendant subjectivities that otherwise inure in a technique heretofore entirely reserved for human realization.

To this end, in a first aspect of the present invention, we disclose a novel computer method comprising the steps of:
i) providing a library-space-requirements database comprising a compendium of library-space-requirements history;
ii) providing a library-space-availability database comprising a compendium of at least one of library-space management solutions, library-space information, and library-space diagnostics;
and
iii) employing a data mining technique for interrogating said library-space-requirements and library-space-availability databases for generating an output data stream, said output data stream correlating requirements problem with availability solution.

The novel method preferably comprises a further step of updating the step i) library-space-requirements database, so that it can cumulatively track the library-space-requirements history as it develops over time. For example, this step i) of updating the library-space-requirements database may include the results of employing the step iii) data mining technique. Also, the method may comprise a step of refining an employed data mining technique in cognizance of pattern changes embedded in each database as a consequence of library-space-solutions results and updating the library-space-requirements database.

The novel method preferably comprises a further step of updating the step ii) library-space-availability database, so that it can cumulatively track an ever increasing and developing technical library-space management literature. For example, this step ii) of updating the library-space-availability database may include the effects of employing a data mining technique on the library-space-requirements database. Also, the method may comprise a step of refining an employed data mining technique in cognizance of pattern changes embedded in each database as a consequence of library-space-solutions results and updating the library-space-solutions database.

The novel method may employ advantageously a wide array of step iii) data mining techniques for interrogating the library-space-requirements and library-space-solutions database for generating an output data stream, which output data stream correlates library-space-requirements problem with library-space availabilty solution. For example, the data mining technique may comprise inter alia employment of the following functions for producing output data: classification-neural, classification-tree, clustering-geoographic, clustering-neural, factor analysis, or principal component analysis, or expert systems.

In a second aspect of the present invention, we disclose a program storage device readable by machine to perform method steps for providing an interactive library-space management database, the method comprising the steps of:
i) providing a library-space-requirements database comprising a compendium of library-space-requirements history;
ii) providing a library-space-availability database comprising a compendium of at least one of library-space management solutions, library-space information, and library-space diagnostics;
and
iii) employing a data mining technique for interrogating said library-space-requirements and library-space-availability databases for generating an output data stream, said output data stream correlating requirements problem with availability solution.

In a third aspect of the present invention, we disclose a computer comprising:
i) means for inputting a library-space-requirements database comprising a compendium of individual library-space-requirements history;
ii) means for inputting a library-space-availability database comprising a compendium of at least one of library-space management solutions, library-space information, and library-space diagnostics;
iii) means for employing a data mining technique for interrogating said library-space-availability databases;
and
iv) means for generating an output data stream, said output data stream correlating library-space-requirements problem with library-space-availability solution.
   We have now summarized the invention in several of its aspects or manifestations. It may be observed, that with respect to the prior art discussed above comprising the three part subjective paradigm approach to the problem of library-space management, that the summarized invention utilizes inter alia, the technique of data mining. We now point out, firstly, that the technique of data mining is of such complexity and utility, that as a technique, in and of itself, it cannot be used in any way as an available candidate solution for library-space management, to the extent that the problem of library-space management is only approached within the realm of the human-subjective solution to library-space management. Moreover, to the extent that the present invention uses computer techniques including e.g., data mining techniques, to an end of solving a problem of library-space management, it is not in general obvious within the context of the nominal problem and the technique of data mining, how they are to be in fact brought into relationship to provide a pragmatic solution to the problem of library-space management. It is rather an aspect of the novelty and unobviousness of the present invention that it discloses, on the one hand, the possibility for using the technique of data mining within the context of library-space management, and, moreover, on the other hand, discloses illustrative techniques that are required to in fact pragmatically bring the technique of data mining to actually solve the problem of library-space management.

### BRIEF DESCRIPTION OF THE DRAWING

The invention is illustrated in the accompanying drawing, in which

FIG. 1 provides an illustrative flowchart comprehending overall realization of the method of the present invention;

FIG. 2 provides an illustrative flowchart of details comprehended in the FIG. 1 flowchart;

FIG. 3 shows a neural network that may be used in realization of the FIGS. 1 and 2 data mining algorithm; and

FIG. 4 shows further illustrative refinements of the FIG. 3 neural network.

### DETAILED DESCRIPTION OF THE PRESENT INVENTION

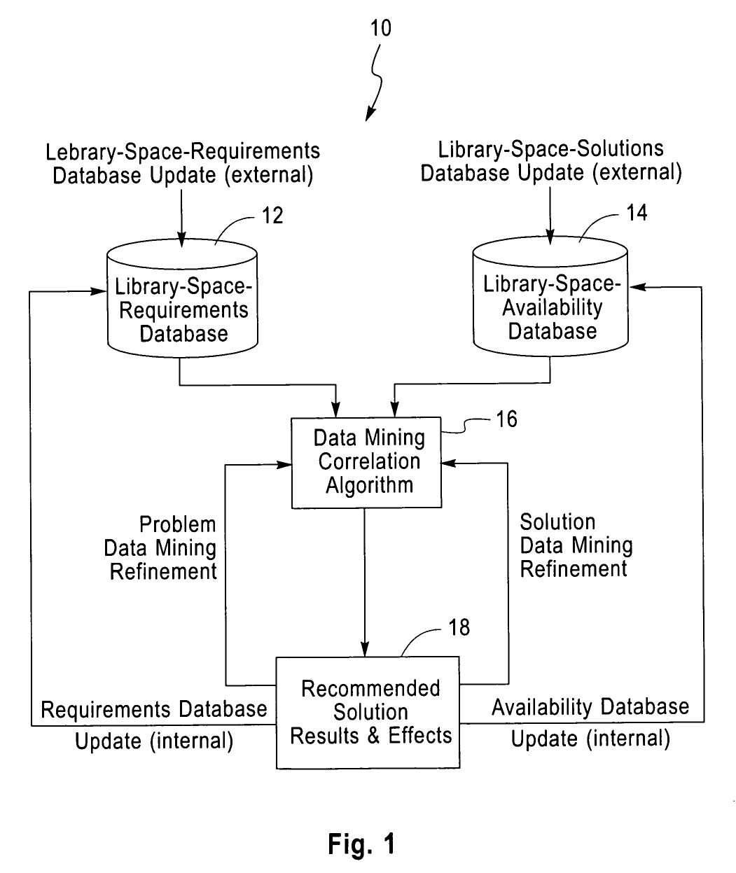

The detailed description of the present invention proceeds by tracing through three quintessential method steps, summarized above, that fairly capture the invention in all its sundry aspects. To this end, attention is directed to the flowcharts and neural networks of FIGS. 1 through 4, which can provide enablement of the three method steps.

FIG. 1, numerals 10-18, illustratively captures the overall spirit of the present invention. In particular, the FIG. 1 flowchart (10) shows a library-space-requirements database (12) comprising a compendium of individual library-space-requirements history, and a library-space-availability database (14) comprising a compendium of at least one of library-space management solutions, library-space information, and library-space diagnostics. Those skilled in the art will have no difficulty, having regard to their own knowledge and this disclosure, in creating or updating the databases (12,14) e.g.; conventional techniques can be used to this end. FIG. 1 also shows the outputs of the library-space-requirements database (12) and library-space-availability database (14) input to a data mining correlation algorithm box (16). The data mining algorithm can interrogate the information captured and/or updated in the library-space-requirements and library-space-availability databases (12,14), and can generate an output data stream (18) correlating library-space-requirements problem with library-space-availability solution. Note that the output (18) of the data mining algorithm can be most advantageously, self-reflexively, fed as a subsequent input to at least one of the library-space-requirements database (12), the library-space-availability database (14), and the data mining correlation algorithm (16).

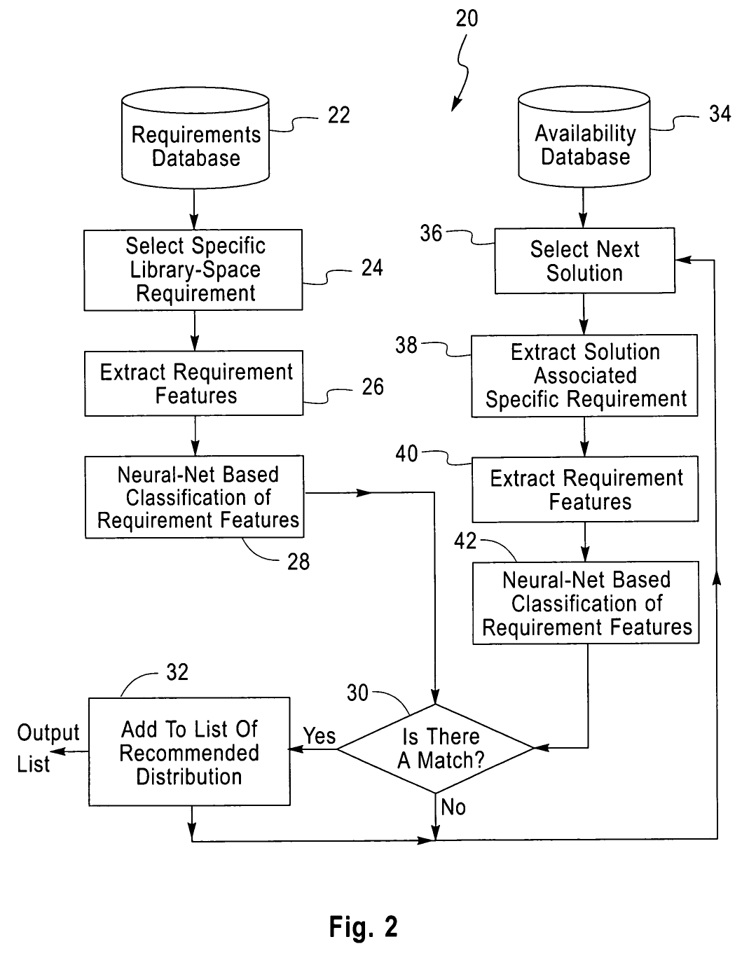

Attention is now directed to FIG. 2, which provides a flowchart (20-42) that recapitulates some of the FIG. 1 flowchart information, but adds particulars on the immediate correlation functionalities required of a data mining correlation algorithm. For illustrative purposes, FIG. 2 comprehends the data mining correlation algorithm as a neural-net based classification of library-space-requirements features, e.g., wherein a library-space-requirements feature for say, subject categories and/or author categories, may include can volume, location, accesability, expected library-space-uses by week, etc.

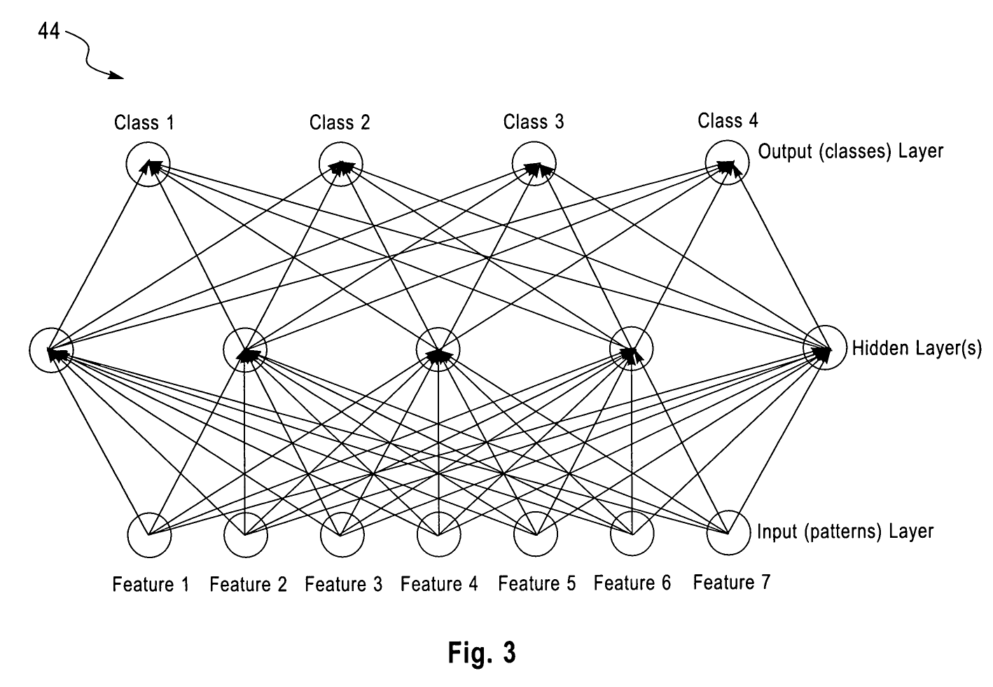

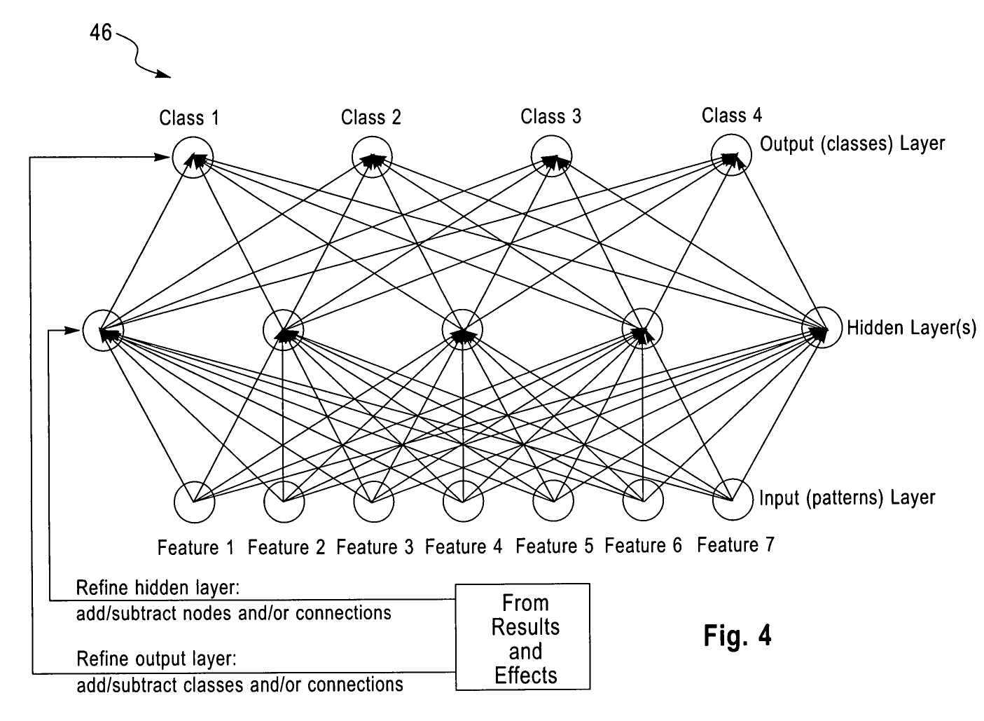

FIG. 3, in turn, shows a neural-net (44) that may be used in realization of the FIGS. 1 and 2 data mining correlation algorithm. Note the reference to classes which represent classification of input features. The FIG. 3 neural-net (44) in turn, may be advantageously refined, as shown in the FIG. 4 neural-net (46), to capture the self-reflexive capabilities of the present invention, as elaborated above.

It is well understood that the computer system and method of the present invention can be implemented using a plurality of separate dedicated or programmable integrated or other electronic circuits or devices (e.g., hardwired or logic circuits such as discrete element circuits, or programmable logic devices such as PLDs, PLAs, PALs, or the like). A suitably programmed general purpose computer, e.g., a microprocessor, microcontroller or other processor devices (CPU or MPU), either alone or in conjuction with one or more peripheral (e.g., integrated circuit) data and signal processing devices can be used to implement the invention. In general, any device or assembly of devices on which a finite state machine capable of implementing the flow charts shown in the figures can be used as a controller with the invention.

What is claimed:

1. A computer method comprising the steps of:
i) providing a library-space-requirements database comprising a compendium of individual library-space-requirements history;
ii) providing a library-space-availability database comprising a compendium of at least one of library-space management solutions, library-space information, and library-space diagnostics; and
iii) employing a data mining technique for interrogating said library-space-requirements and library-space-availability databases for generating an output data stream, said output data stream correlating library-space-requirements problem with library-space-availability solution.

2. A method according to claim 1, comprising a step of updating the library-space-requirements database.

3. A method according to claim 2, comprising a step of updating the library-space-requirements database so that it includes the results of employing a data mining technique.

4. A method according to claim 1, comprising a step of updating the library-space-availability database.

5. A method according to claim 4, comprising a step of updating the library-space-availability database so that it includes the effects of employing a data mining technique on the library-space-requirements database.

6. A method according to claim 2, comprising a step of refining a employed data mining technique in cognizance of pattern changes embedded in each database as a consequence of updating the library-space-requirements database.

7. A method according to claim 4, comprising a step of refining a employed data mining technique in cognizance of pattern changes embedded in each database as a consequence of updating the library-space-availability database.

8. A method according to claim 1, comprising a step of employing neural networks as the data mining technique.

9. A program storage device readable by machine, tangibly embodying a program of instructions executable by the machine to perform method steps for providing an interactive library-space management database, the method comprising the steps of:
i) providing a library-space-requirements database comprising a compendium of individual library-space-requirements history;
ii) providing a library-space-availability database comprising a compendium of at least one of library-space management solutions, library-space information, and library-space diagnostics;
and
iii) employing a data mining technique for interrogating said library-space-requirements and library-space-availability databases for generating an output data stream, said output data stream correlating library-space-requirements problem with library-space-availability solution.

10. A computer comprising:
i) means for inputting a library-space-requirements database comprising a compendium of individual library-space-requirements history;
ii) means for inputting a library-space-availability database comprising a compendium of at least one of library-space management solutions, library-space information, and library-space diagnostics;
iii) means for employing a data mining technique for interrogating said library-space-requirements and library-space-availability databases;
and
iv) means for generating an output data stream, said output data stream correlating library-space-requirements problem with library-space-availability solution.
